(19) United States
(12) Patent Application Publication
(10) Pub. No.: US 2019/0146300 A1
(43) Pub. Date: May 16, 2019

(54) METHOD AND APPARATUS FOR AN ENHANCED BRIGHTNESS TIR IMAGE DISPLAY

(71) Applicant: CLEARInk Displays, Inc., Premont, CA (US)

(72) Inventors: Bram M. Sadlik, Vancouver (CA); Thomas Johansson, Coquitlam (CA)

(73) Assignee: CLEARInk Displays, Inc., Fremont, CA (US)

(21) Appl. No.: 16/095,649

(22) PCT Filed: Apr. 24, 2017
(86) PCT No.: PCT/US17/29144

§ 371 Date: Oct. 22, 2018

Related U.S. Application Data
(60) Provisional application No. 62/327,065, filed on Apr. 25, 2016.

(51) Int. Cl. G02F 1/16755; G02F 1/167; G02F 1/1676; G02F 1/1343; G02F 1/1677; G02F 1/1335

(52) U.S. Cl. CPC G02F 1/16755; G02F 1/167; G02F 1/1676; G02F 2203/023; G02F 1/1677; G02F 1/133514; G02F 1/13439

(57) ABSTRACT

Brightness in conventional total internal reflection image displays may decrease due to incident light passing through the dark pupil region in the white state. Certain embodiments of the disclosure relate to an enhanced brightness total internal reflection-based image display utilizing a front sheet having an array of modified hemispherical protrusions with a partially light reflective surface. Modifying the structure of the convex protrusions of the transparent front sheet and adding a light reflective layer on specific areas of the protrusions may increase brightness in the white state. Controlling the size, depth and angle of the structure of the convex protrusions may direct incident light by one or more of total internal reflection and specular reflection in a controllable manner to enhance brightness of the display.

The disclosure claims the filing data priority of U.S. Provisional Application No. 62/327,065, filed on Apr. 25, 2016, the specification of which is incorporated herein in its entirety.

### FIELD

The disclosed embodiments generally relate to total internal reflection-based image displays. In one embodiment, the disclosure relates to an enhanced brightness total internal reflection-based image display utilizing a front sheet having an array of modified hemispherical protrusions with a partially light reflective surface.

### BACKGROUND

Conventional total internal reflection (TIR) based displays include, among others, a transparent high refractive index front sheet in contact with a low refractive index fluid. The front sheet and fluid may have different refractive indices that may be characterized by a critical angle θ_{c}. The critical angle characterizes the interface between the surface of the transparent front sheet (with refractive index η₁) and the low refractive index fluid (with refractive index η₃). Light rays incident upon the interface at angles less than θ_{c} may be transmitted through the interface. Light rays incident upon the interface at angles greater than θ_{c} may undergo TIR at the interface. A small critical angle (e.g., less than about 50°) is preferred at the TIR interface since this affords a large range of angles over which TIR may occur. It may be prudent to have a fluid medium with preferably as small a refractive index (η₃) as possible and to have a transparent front sheet composed of a material having a refractive index (η₁) preferably as large as possible. The critical angle, θ_{c}, is calculated by the following equation (Eq. 1):

$${θ}_{c} = {sin}^{- 1} ( \frac{{η}_{3}}{{η}_{1}} ) \qquad ( 1 )$$

Conventional TIR-based reflective image displays further include electrophoretically mobile, light absorbing particles. The electrophoretically mobile particles move in response to a bias between two opposing electrodes. When particles are moved by a voltage bias source to the surface of the front sheet they may enter the evanescent wave region and frustrate TIR. Incident light may be absorbed by the electrophoretically mobile particles to create a dark state observed by the viewer. Under such conditions, the display surface may appear dark or black to the viewer. When the particles are moved out of the evanescent wave region (e.g., by reverse biasing), light may be reflected by TIR. This creates a white or bright state that may be observed by the viewer. An array of pixelated electrodes may be used to drive the particles into and out of the evanescent wave region to form combinations of white and dark states. This may be used to create images or to convey information to the viewer.

The front sheet in conventional TIR-based displays typically includes a plurality of close-packed convex structures on the inward side facing the low refractive index medium and electrophoretically mobile particles (i.e., the surface of the front sheet which faces away from the viewer). The convex structures may be hemispherically-shaped but other shapes may be used. A conventional TIR-based display 100 is illustrated in FIG. 1. Display 100 is shown with a transparent front sheet 102 further comprising a layer of a plurality of hemispherical protrusions 104, a rear support sheet 106, a transparent front electrode 108 on the surface of the hemispherical protrusions and a rear electrode 110. FIG. 1 also shows low refractive index fluid 112 which is disposed within the cavity or gap formed between the surface of protrusions 104 and the rear support sheet. The fluid 112 contains a plurality of light absorbing electrophoretically mobile particles 114. Display 100 includes a voltage source 116 capable of creating a bias across the cavity. When particles 114 are electrophoretically moved near the front electrode 108, they may frustrate TIR. This is shown to the right of dotted line 118 and is illustrated by incident light rays 120 and 122 being absorbed by the particles 114. This area of the display will appear as a dark state to viewer 124.

When particles are moved away from front sheet 102 towards rear electrode 110 (as shown to the left of dotted line 118) incident light rays may be totally internally reflected at the interface of the surface of electrode 108 on hemispherical array 104 and medium 112. This is represented by incident light ray 126, which is totally internally reflected and exits the display towards viewer 124 as reflected light ray 128. The display appears white or bright to the viewer.

In some instances, light rays may not be totally internally reflected and may instead pass through front sheet 102 and then be lost or internally absorbed. Such conditions decrease the overall brightness of the display. Light ray 130 in FIG. 1 represents a light ray that is incident on the interface at less than the critical angle. Light ray 130 passes through the so called dark pupil region and is not reflected. Thus, brightness in conventional total internal reflection image displays may decrease due to incident light passing through the dark pupil region in the white state. There is a need for an improved TIR display and method for totally internally reflecting light with enhanced brightness.

### BRIEF DESCRIPTION OF DRAWINGS

These and other embodiments of the disclosure will be discussed with reference to the following exemplary and non-limiting illustrations, in which like elements are numbered similarly, and where:

FIG. 1 schematically illustrates a cross-section of a portion of a conventional TIR-based display;

FIG. 2A schematically illustrates a top view of a modified convex structure with a reflective surface according to one embodiment of the disclosure;

FIG. 2B schematically illustrates a side view modified convex structure with a reflective surface according to one embodiment of the disclosure;

FIG. 2C schematically illustrates a tilted view of a modified convex structure with a reflective surface according to one embodiment of the disclosure;

FIG. 3 schematically illustrates a cross-section of a portion of a front sheet comprising a plurality of modified convex structures according to one embodiment of the disclosure;

FIG. 4 schematically illustrates a cross-section of a portion of a TIR-based image display according to another embodiment of the disclosure;

FIG. 5 shows an exemplary system for controlling a display according to one embodiment of the disclosure; and

FIG. 6 graphically illustrates the results of a set of simulations.

### DETAILED DESCRIPTION

Throughout the following description specific details are set forth in order to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive or exclusive, sense.

This disclosure generally relates to an enhanced brightness TIR image display.

According to certain embodiments of the disclosure, the convex protrusions on the front sheet may be modified to enhance brightness of the white state compared to conventional TIR-based displays. In certain embodiments, the convex structures may be modified and may further include a light reflection layer. In certain other embodiments, the modified convex structures may further include specific areas or regions of the structures that comprises a light reflection layer. In still other embodiments, a portion of the TIR image display reflects light by TIR and a portion by specular reflection.

The modified structures and light reflection areas may prevent light rays from passing through the dark pupil region and instead reflect incident light rays back towards the viewer in a specular manner to enhance brightness. In some embodiments, the light reflection areas may be metallic. In an exemplary embodiment, at least one electrophoretically mobile particle contained within a fluid medium may be moved by application of a voltage bias to one or more of frustrate TIR or absorb incident light rays at the front sheet to form a dark state. In an exemplary embodiment, a color filter array layer may be interposed between the front sheet and the modified convex structures.

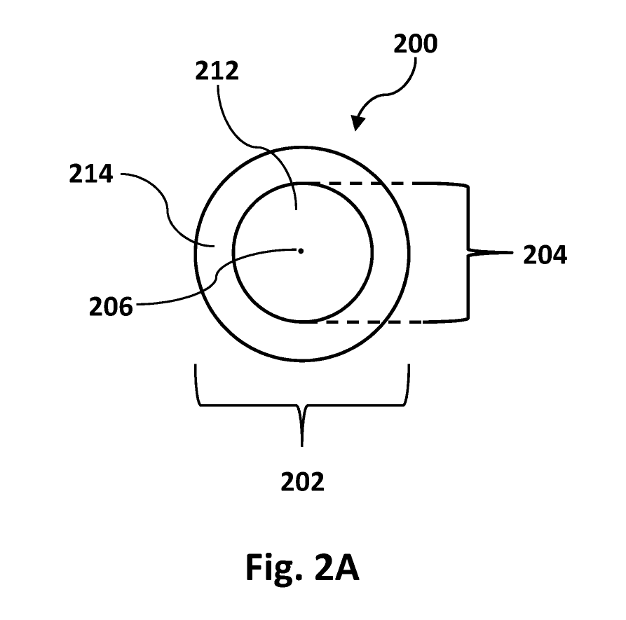

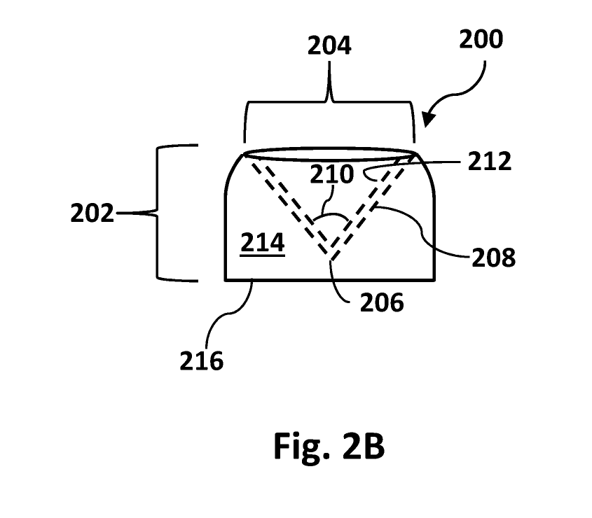

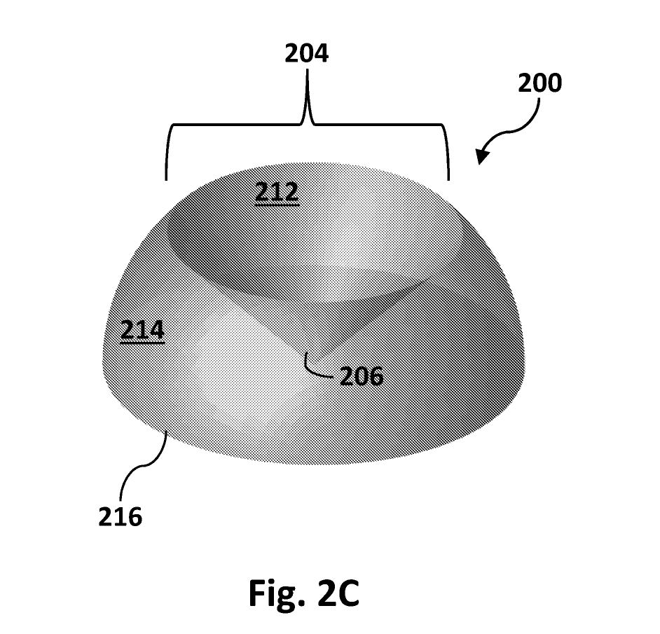

FIGS. 2A-C schematically illustrates different views of a modified convex structure (may also be referred to as a convex protrusion) with a light reflective surface according to one embodiment of the disclosure. Specifically, FIG. 2A schematically illustrates the top view of the modified convex structure with a reflective surface according to one embodiment of the disclosure; FIG. 2B schematically illustrates a side view of the modified convex structure with a reflective surface according to one embodiment of the disclosure; and FIG. 2C schematically illustrates a tilted view of the modified convex structure with a reflective surface according to one embodiment of the disclosure. Embodiment 200 in FIGS. 2A-C will be described herein simultaneously.

The modified convex structure embodiment in FIGS. 2A-C is in the shape of a truncated hemispherical protrusion 202 with portion 204 of the structure removed. In other embodiments structure 202 may be in shapes other than a truncated hemispherical protrusion such as an elongated hemisphere or a hexagonal-like structure. Structure 202 may comprise a high refractive index polymer. Structure 202 may include a polymer having a high refractive index metal oxide additive such as one or more of ZrO₂ or TiO₂. In some embodiments, the refractive index of 202 may be about 1.5 to 2.2. In other embodiments the refractive index of structure 202 may be about 1.6 to 2.2. In an exemplary embodiment the refractive index of structure 202 may be about 1.6-1.9. It is understood that the refractive index may vary from the exemplary ranges provided herein without departing from the disclosed principles.

In embodiment 200 the removed portion 204 is in the shape of a cone. Other shapes of the removed portion may be used in other embodiments. The portion of the hemisphere with the cone shaped portion removed may also be referred to as a divot or empty space and may be referred to interchangeably. In some embodiments, the removed portion may be in the shape of a trigonal pyramid. In other embodiments the removed portion may be in the shape of a square pyramid or other pyramidal-like shape. The removed portion may create an opening 204 in the modified convex structure. In other embodiments the divot opening may be circular, square-like or rectangular-like, elongated oval or other shape. The deepest portion of the removed cone shaped structure in embodiment 200 is denoted as point 206. The removed portion may create an inner surface 208. The inner surfaces may define angle 210 when viewing from the side. In some embodiments the angle may be about 10-80°. In other embodiments the angle may be about 20-70°. In still other embodiments the angle may be about 30-60°. In an exemplary embodiment the angle may be about 40-50°.

On the inward surface 208 of the circular divot in embodiment 200, a light reflection material may be deposited such as aluminum, gold, silver or other metal to form coating 212. In some embodiments the reflective surface may comprise a metal oxide such as sintered TiO₂, a multi-layer dielectric structure or a non-metallic reflector. On the outward surface 214 of hemisphere 202 there may not be a reflective surface in order to allow light rays to pass through. In some embodiments, a portion of outer surface 214 may be coated by a light reflection layer. In certain implementation, the outer portion may be semi-reflective.

The bottom surface 216 of convex structure 202 may be adjacent one or more of a color filter array layer, light diffuser layer or transparent front sheet. Structure 202 may be continuous with a transparent front sheet.

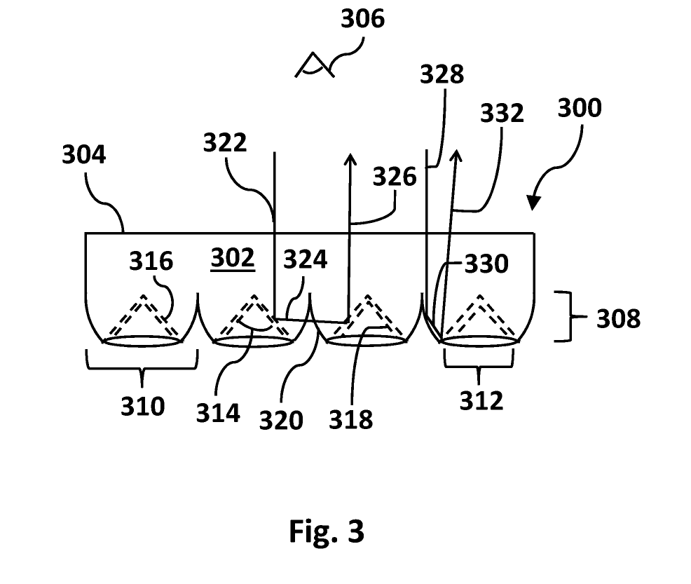

FIG. 3 schematically illustrates a cross-section of a portion of a front sheet comprising a plurality of modified convex structures according to one embodiment of the disclosure. Front sheet embodiment 300 in FIG. 3 comprises a transparent front sheet 302 with an outward surface 304 facing viewer 306. Sheet 302 further comprises a layer 308 of modified convex hemispherical protrusions 310 as previously described herein. For brevity, hemispherically-shaped convex protrusions (with a divot) will be described herein to illustrate the disclosed principles, though other shapes or combinations of shapes may also be equally used.

Divot 312 may be cut away or removed from each hemisphere 310 to form an opening. Conventional manufacturing techniques can be used to form the divot. In embodiment 300, the removed portion 312 is in the shape of a cone. As stated, other shapes of the removed portion may be used as described previously herein. The depth of the cone may be controlled by controlling angle(s) 314 formed by the sides of the cone. The larger the angle the shallower the cone. Angle 314 and depth of the cone may depend on the application of the display. In other embodiments, the width, depth and angle 314 of the divot may vary from modified structure to modified structure within layer 308. The width, depth, and angle 314 of the divot may vary in a random manner or a semi-random manner. In some embodiments, the array 308 of convex protrusions 310 may comprise of various sizes and shapes in a random or semi-random manner.

In some embodiments, the front sheet 302 and layer of convex protrusions 308 may be a continuous layer. In an exemplary embodiment, front sheet 302 and layer of convex protrusions 308 may define separate layers. In an exemplary embodiment, front sheet 302 may comprise glass. Front sheet 302 may comprise a polymer such as polycarbonate. In an exemplary embodiment, layer of protrusions 308 may comprise a high refractive index polymer. In some embodiments the refractive index of layer 302 or convex protrusions 308 or both layer 302 and protrusions 308 may be about 1.5 to about 2.2. In other embodiments the refractive index of layer 302 or protrusions 308 may be about 1.6 to about 2.2. In an exemplary embodiment the refractive index of layer 302 or protrusions 308 may be about 1.6 to about 1.9.

In an exemplary embodiment, a color filter array layer may be interposed between the transparent front sheet 302 and layer of convex protrusions 308. The color filter array layer may be further comprised of red, green and blue filters or cyan, magenta and yellow filters. In other embodiments a color filter array layer may be located on the outer surface of front sheet 302 facing viewer 306.

The surface of the removed portions or divots 316 of the convex protrusions in layer 308 may further comprise of a light reflection layer 318. Layer 318 may comprise of a metal, metal oxide or other light reflective material. Layer 318 may be deposited by any combination of such methods as embossing, printing, masking, shadow masking, etching, sputtering, or other thin film deposition techniques or other photolithographic techniques.

Front sheet design 300 may further comprise a transparent front electrode (not shown in FIG. 3) on the surface of the array 308 of protrusions. In some embodiments the front electrode may only cover the outward surface 320 of the protrusions. In other embodiments, the transparent front electrode may only cover surface 318. In still other embodiments, the transparent front electrode may cover the entire surface of the convex protrusions 310. This may include both surfaces 318 and 320. The front electrode layer may include one or more of indium tin oxide (ITO), an electrically conducting polymer such as BAYTRON™ or conductive nanoparticles, metal nanowires, graphene or other conductive carbon allotropes or a combination of these materials dispersed in a substantially transparent polymer.

Front sheet design 300 may reflect light as illustrated by incident light rays 322 and 324 in FIG. 3. In a first representative reflection mode, incident light ray 322 may pass through transparent front sheet 302 and reflect off of reflective layer 318. This is depicted by reflected light ray 324. Light ray 324 may then be reflected off of reflective layer 318 of an adjacent hemispherical protrusion. This is illustrated by reflected light ray 326 that is reflected back towards viewer 306. In conventional TIR-based displays, light that enters the display at the angle depicted in FIG. 3 by light ray 322 would typically pass through the dark pupil region of the protrusions and enter the medium where the light rays may be lost. This lowers the overall brightness of the display.

A second representative reflection mode is illustrated in FIG. 3 by incident light ray 328. In this example, light rays may be reflected by a combination of TR and specular reflection. Light ray 328 may pass through sheet 302 and may be incident at the interface of the outward surface of a high refractive index protrusion 310 and a low refractive index medium at an angle greater than the critical angle, θ_{c}, such that the light ray is totally internally reflected. This is represented by totally internally reflected light ray 330. Light ray 330 may then be reflected towards reflective layer 318 where the light ray may be reflected back towards viewer 306 as reflected light ray 332.

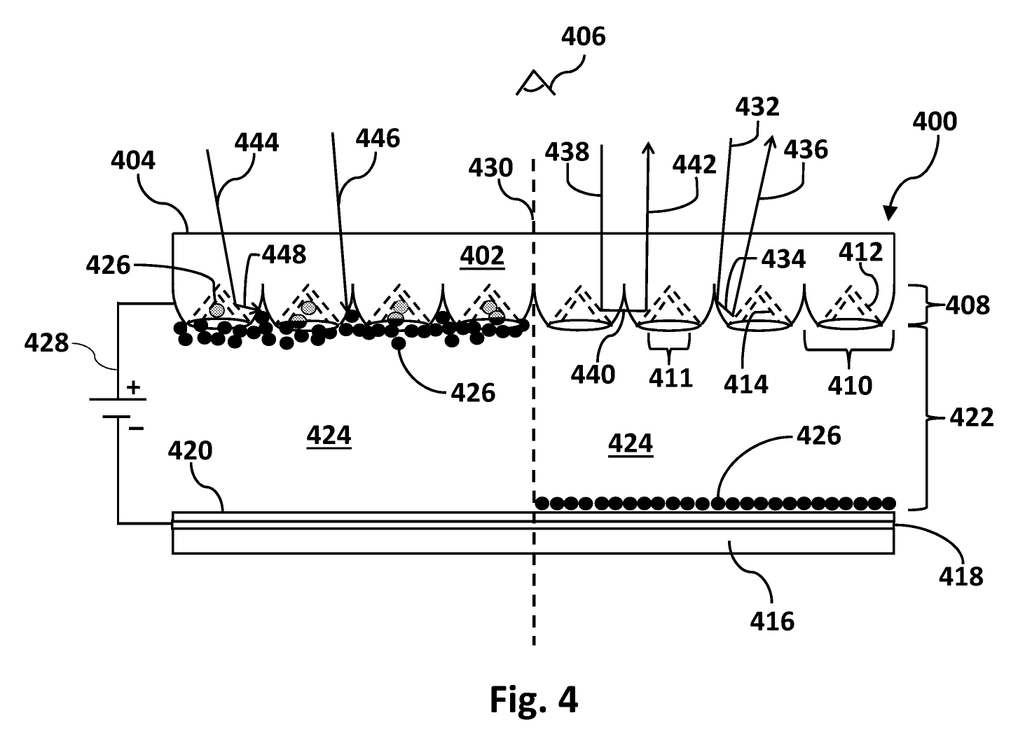

FIG. 4 schematically illustrates a cross-section of a portion of a TIR-based image display according to one embodiment of the disclosure. Image display device embodiment 400 in FIG. 4 comprises transparent front sheet 402 with front or outer surface 404 facing viewer 406. Sheet 402 further comprises a layer of an array 408 of individual modified convex protrusions 410 on an inward surface. Protrusions 410 may be truncated hemispheres as shown in FIG. 4 and described previously herein in embodiments 200 and 300 in FIGS. 2A-C and FIG. 3, respectively. The modified protrusions may also be other shapes. In certain embodiments, the high refractive index protrusions 410 may include materials having a refractive index in the range of about 1.5 to 2.2. In certain other embodiments, the high refractive index protrusions may be a material having a refractive index of about 1.6 to about 1.9. In some embodiments, front sheet 402 and protrusions 410 may be a continuous sheet of substantially the same material. In other embodiments, front sheet 402 and protrusions 410 may be formed of different materials having similar or different refractive indices as previously described herein.

Protrusions 410 may comprise of a divot 411 where a portion of the protrusion has been removed. Other shapes of divots may also be used. Divots 411 comprises an inner surface 412. Surface 412 may further comprise a light reflection layer 414.

Sheet 402 may further include a transparent front electrode (not shown in FIG. 4) on the surface of the modified hemispherical convex protrusions. In some embodiments the transparent front electrode may cover a portion of the surface of sheet 402 and light reflection layer 414. In an exemplary embodiment, the transparent front electrode may cover the entire surface of front sheet 402 and light reflective layer 414. In other embodiments, the front electrode may only be located on the surface of the modified convex protrusions 410 and not on the inner light reflective surface 414. The transparent front electrode may comprise a transparent conductive material such as indium tin oxide (ITO), Baytron™, or conductive nanoparticles, metal nanowires, graphene or other conductive carbon allotropes or a combination of these or similar material(s) dispersed in a substantially transparent polymer.

Image display embodiment 400 includes rear support layer 416. Rear electrode layer 418 may be positioned on the inward side of layer 416. Rear electrode 418 may include one or more of a thin film transistor (TFT) array, patterned direct drive array or a passive matrix array of electrodes. Rear electrode 418 may be integrated with rear support layer 416. Alternatively, rear electrode 418 may be positioned proximal to rear support 416. In still another embodiment, rear electrode 418 may be laminated or attached to rear support 416.

In some embodiments an optional dielectric layer (not shown in FIG. 4) may be located on the surface of the transparent front electrode. In other embodiments an optional dielectric layer 420 may be located on top of the rear electrode layer 418. In some embodiments, the dielectric layer on the front electrode may comprise of a different composition than the dielectric layer on rear electrode 418. The dielectric layers may be substantially uniform, continuous and substantially free of surface defects. The dielectric layer may be about 5 nm in thickness or more. In some embodiments, the dielectric layer thickness may be about 5 to 300 nm. In other embodiments, the dielectric layer thickness may be about 5 to 200 nm. In still other embodiments, the dielectric layer thickness may be about 5 to 100 nm. The dielectric layers may each have a thickness of at least about 80 nanometers. In an exemplary embodiment, the thickness may be about 80-200 nanometers. The one or more dielectric layers may comprise at least one pin hole. The dielectric layer may define a conformal coating and may be free of pin holes or may have minimal pin holes. The dielectric layer may also be a structured layer. Dielectric compounds may be organic or inorganic in type. In some embodiments the dielectric layer may be alumina (Al₂O₃) or SiO₂. The dielectric layer may be SiNₓ. In some embodiments the dielectric layer may be Si₃N₄. Organic dielectric materials are typically polymers such as polyimides, fluoropolymers, polynorbornenes and hydrocarbon-based polymers lacking polar groups. The dielectric layer may be a polymer or a combination of polymers. In an exemplary embodiment, the dielectric layers comprise parylene. In other embodiments, the dielectric layers may comprise a halogenated parylene. Other inorganic or organic dielectric materials or combinations thereof may also be used for the dielectric layers.

Within gap or cavity 422 formed by front sheet 402 and rear sheet 416 in display embodiment 400 can be configured to receive medium 424. Medium 424 may be air or a liquid. In some embodiments, medium 424 may be a hydrocarbon. In other embodiments, medium 424 may be a fluorinated hydrocarbon or a perfluorinated hydrocarbon. In other embodiments, medium 424 may be a mixture of a hydrocarbon and a fluorinated hydrocarbon. Medium 424 may be a low refractive index liquid with a refractive index less than about 1.5. In an exemplary embodiment the refractive index of medium 424 may be about 1.1-1.4. In an exemplary embodiment, medium 424 may comprise one or more of Fluorinert™, Novec™ 7000, Novec™ 7100, Novec™ 7300, Novec™ 7500, Novec™ 7700 or Novec™ 8200. Medium 424 may further comprise one or more of a dispersant, charging agent, surfactant, flocculating agent, viscosity modifier or a polymer. Conventional viscosity modifiers include oligomers or polymers. Viscosity modifiers may include one or more of a styrene, acrylate, methacrylate or other olefin-based polymers. In one embodiment, the viscosity modifier may be polyisobutylene or a halogenated polyisobutylene.

Medium 424 may further include a plurality of light absorbing electrophoretically mobile particles 426 of a first optical characteristic (i.e. color or light absorption characteristic). Particles 426 may comprise a positive or negative charge polarity. Particles 426 may have broadband (i.e., substantially all optical wavelengths) light reflection characteristics. Particles 426 may also have any light absorption characteristics such that they may impart any color of the visible spectrum or a combination of colors to give a specific shade or hue. Particles 426 may be a dye or pigment or a combination thereof. The particles may be organic or inorganic or a combination thereof. Particles 426 may comprise of a metal oxide. Particles 426 may comprise of carbon black.

In another embodiment medium 424 may further comprise a second plurality of particles (not shown in FIG. 4) of a second optical characteristic. The second plurality of particles may comprise a charge polarity or may be weakly charged or uncharged. The second plurality of particles may include light absorbing or light reflecting. In an exemplary embodiment, the second plurality of non-light absorbing particles may comprise TiO₂.

Display 400 may further include a voltage bias source 428. The bias source may be used to create an electromagnetic flux across medium 424 in cavity 422 between the front electrode and rear electrode layer 418. The electromagnetic flux may electrophoretically move at least one particle of the first plurality of particles 426 or at least one particle of an optional second plurality of particles. The flux may be used to move the plurality of particles 426 to the front or rear 418 electrodes or anywhere in between the front and rear electrodes. The flux may be provided and/or adjusted by a controller (e.g., a processor circuitry and optionally a memory circuitry) configured to move mobile particles from one location to another to display information to a viewer.

The voltage source 428 may be coupled to one or more processor circuitry and memory circuitry configured to change or switch the applied bias in a predefined manner and/or for predetermined durations. For example, the processing circuitry may switch the applied bias to display characters on display 400.

In certain embodiments, display 400 may be operated as follows. For illustrative purposes only, it is assumed that one or more of the plurality of particles 426 comprise a positive charge polarity. In other embodiments, particles 426 may comprise a negative charge polarity. On the right side of dotted line 430, a negative voltage bias may be applied by voltage bias source 428 at rear electrode 418 to attract the positively charged light absorbing particles 426 to the rear electrode 418. As a result, total internal reflection of incident light may not be frustrated by particles 426. In a first example mode of reflection, incident light ray 432 may be totally internally reflected at the interface of front sheet 402 and lower refractive index medium 424 as reflected light ray 434. Light ray 434 may then be reflected towards reflective surface 414 of an adjacent modified convex protrusion 410 back towards viewer 406. This may be represented by light ray 436.

Light reflection and transmission may also be allowed to occur from reflective surface 414 of a first modified hemispherical protrusion to an adjacent reflective surface 414 of second modified hemispherical convex protrusions 410 of front sheet 402. This is represented by incident light ray 438 and reflected light ray 440. In a second example mode of reflection illustrated and represented by incident light ray 438 in FIG. 4, light ray 438 may be first reflected at the reflective surface 414 as reflected light ray 440. Light ray 440 may be reflected toward reflective surface 414 of an adjacent convex protrusion 410 comprising of surface 414. The light ray may be reflected at least a second time as illustrated by reflected light ray 442. Light ray 442 may be reflected back towards viewer 406. This may create an enhanced bright or white state appearance of a pixel of display 400 to viewer 406. The cone shaped metallic reflector depicted in FIGS. 3 and 4 is introduced into the front sheet in such a way that it reflects light from what would have been the dark pupil of one hemispherical convex protrusion onto the reflective layer of a nearest neighbor or a non-nearest neighbor convex protrusion or a combination thereof. It should be noted that the reflection modes described herein are for illustrative purposes only. Other combinations of TIR and specular-like reflection may be possible.

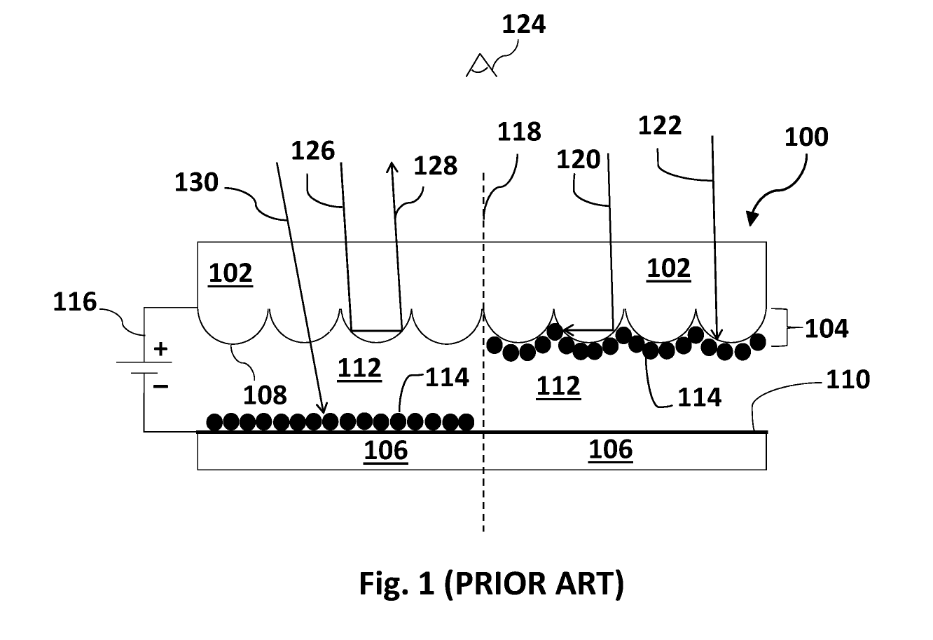

The non-modified hemisphere structure 100 illustrated in FIG. 1 is semi-retro-reflective. Introducing the reflective cone into this structure changes this behavior to semi-specular due to light reflection layer 414. Furthermore, because the cone is a scattering structure, the design described herein may increase the viewing angle relative to non-modified convex hemispherical structures. In other embodiments an optional light diffusive layer may be added to “soften” the reflected light viewed by the viewer 406. The optional light diffusive layer may be located on the outer surface 404 of front sheet 402.

In certain embodiments, display 400 may also be capable of forming a dark state as shown on the left side of dotted line 430. Applying a negative voltage bias by bias source 428 at a front electrode (not shown) located on the surface of array 408 may attract the positively charged light absorbing particles 426 towards the front electrode layer (It should be noted that particles 426 that are lighter in color in FIG. 4 denote those particles that have been electrophoretically moved and collected at surface 414 inside divots 411 of the modified hemispherical protrusions. Highlighting particles 426 in gray is for illustrative purposes only). In this location at the front electrode, particles 426 may absorb light or frustrate TIR to create a dark state of a pixel of display 400. This is illustrated and represented by incident light rays 444 and 446 on the left side of dotted line 430. Light ray 444 may pass through top sheet 402 and onto light reflective surface 414 and be reflected as light ray 448. Light ray 448 may be directed towards adjacent truncated hemispherical protrusions through medium 424. Particles 426 residing in the spaces between the hemispherical protrusions may absorb the reflected light rays. This is illustrated by light ray 448 being absorbed by particles 426. In a second example of a mode of light absorption, light rays that pass through front sheet 402 may not initially reflect off of the light reflection layer 414. Instead, light rays may pass through front sheet 402 and be absorbed by particles 426 residing at the inward surface of front sheet 402. In this location, TIR may be frustrated by the presence of particles 426 in the evanescent wave region. This is represented by light ray 446. This creates a dark state of a pixel within display 400. The color the viewer 406 may observe may depend on the optical properties of the light absorbing particles used in the display application. Combinations of white and dark pixel states created by the display design embodiments and by the methods and processes described herein may create images to convey information to the viewers of the display.

In other embodiments, any of the display embodiments described herein may comprise a plurality of light reflecting particles and a plurality of light absorbing particles of the same charge polarity.

In other embodiments, any of the reflective image display embodiments disclosed herein may further include at least one spacer structure. The spacer structures may be used to control the gap between the front and rear electrodes. Spacer structures may be used to support the various layers in the displays. The spacer structures may be in the shape of circular or oval beads, blocks, cylinders or other geometrical shapes or combinations thereof. The spacer structures may comprise glass, metal, plastic or other resin or a combination thereof.

In other embodiments, a color filter layer may be employed with the disclosed display embodiments. The color filter layer may be located over the outward surface of the transparent front sheet facing the viewer. In an exemplary embodiment, the color filter layer may be located between the outer transparent layer and the plurality of convex protrusions. In another exemplary embodiment, the plurality of convex protrusions may be formed directly on the color filter layer. The color filter layer may include, among others, red, green and blue filters or cyan, magenta and yellow filters.

At least one edge seal may be employed with the disclosed display embodiments. The edge seal may prevent ingress of moisture or other environmental contaminants from entering the display. The edge seal may be used to seal the front sheet to the rear sheet. The edge seal may be a thermally, chemically or a radiation cured material or a combination thereof. The edge seal may comprise one or more of an epoxy, silicone, polyisobutylene, acrylate or other polymer based material. In some embodiments the edge seal may comprise a metallized foil. In some embodiments the edge sealant may comprise a filler, such as SiO₂ or Al₂O₃.

At least one sidewall (may also be referred to as cross-walls or partition walls) may be employed with the disclosed display embodiments. The sidewalls may limit particle settling, drift and diffusion to improve display performance and bistability. The sidewalls may be located within the light modulation layer comprising the particles and medium. The sidewalls may completely or partially extend from the front electrode, rear electrode or both the front and rear electrodes. The sidewalls may completely or partially extend from the front sheet, rear support sheet or both the front and rear sheets. The sidewalls may be continuous with the front sheet or the rear sheet or both the front and rear sheets. The sidewalls may comprise plastic, metal or glass or a combination thereof. The sidewalls may be any size or shape. The sidewalls may have a rounded cross-section. The sidewalls may have a refractive index about the same as the refractive index of the convex protrusions. In an exemplary embodiment the sidewalls may be optically active. The sidewalls may create wells or compartments (not shown) to confine the electrophoretically mobile particles. The sidewalls or cross-walls may be configured to create wells or compartments in, for example, square-like, triangular, pentagonal or hexagonal shapes or a combination thereof. The side walls may comprise a polymeric material and patterned by one or more conventional techniques including photolithography, embossing or molding. The sidewalls may help confine the mobile particles to prevent settling and migration of said particles that may lead to poor display performance over time. In certain embodiments, the displays may include sidewalls that completely bridge the gap created by the front and rear electrodes in the region where the air or liquid medium and the electrophoretically mobile particles reside. In certain other embodiments, the reflective image display described herein may comprise partial sidewalls that only partially bridge the gap created by the front and rear electrodes in the region where the air or liquid medium and the mobile particles reside. In certain embodiments, the reflective image display may further include a combination of sidewalls and partial sidewalls that may completely and partially bridge the gap created by the front and rear electrodes in the region where the medium and the electrophoretically mobile particles reside.

A directional front light may be employed with the disclosed display embodiments. The directional front light system may include a light source, light guide and an array of light extractor elements on the outward surface of the front sheet in each display. The directional light system may be positioned between the outward surface of the front sheet and the viewer. The front light source may define a light emitting diode (LED), cold cathode fluorescent lamp (CCFL) or a surface mount technology (SMT) incandescent lamp. The light guide may be configured to direct light to the front entire surface of the transparent outer sheet while the light extractor elements direct the light in a perpendicular direction within a narrow angle, for example, centered about a 30° cone, towards the front sheet. A directional front light system may be used in combination with cross-walls or a color filter layer in the display architectures described herein or a combination thereof. In some embodiment, the directional front light system may be flexible.

In some embodiments, a light diffusive layer may be employed with the disclosed display embodiments. In other embodiments, a light diffusive layer may be used in combination with a front light. In some embodiments, the light diffusive layer may be positioned over front sheet 402 facing viewer 406. In other embodiments, the light diffusive layer may be interposed between the front sheet 402 and layer of convex protrusions 408.

In some embodiments, a porous reflective layer may be used in combination with the disclosed display embodiments. The porous reflective layer may be interposed between the front and rear electrode layers. In other embodiments, the front electrode may be located on the outward surface of the porous reflective layer.

Various control mechanisms for the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

In some embodiments, a tangible machine-readable non-transitory storage medium that contains instructions may be used in combination with the disclosed display embodiments. In other embodiments, the tangible machine-readable non-transitory storage medium may be further used in combination with one or more processors.

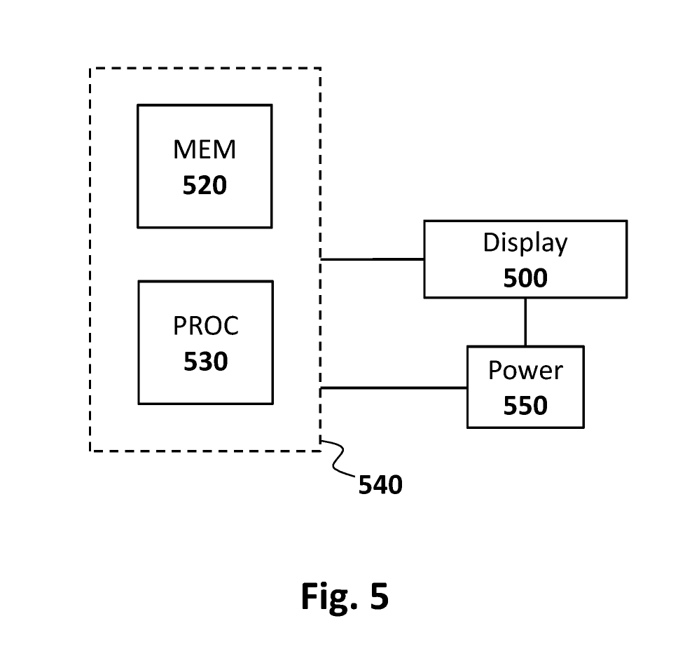

FIG. 5 shows an exemplary system for controlling a display according to one embodiment of the disclosure. In FIG. 5, display 500 is controlled by controller 540 having processor 530 and memory 520. Other control mechanisms and/or devices may be included in controller 540 without departing from the disclosed principles. Controller 540 may define hardware, software or a combination of hardware and software. For example, controller 540 may define a processor programmed with instructions (e.g., firmware). Processor 530 may be an actual processor or a virtual processor. Similarly, memory 520 may be an actual memory (i.e., hardware) or virtual memory (i.e., software).

Memory 520 may store instructions to be executed by processor 530 for driving display 400. The instructions may be configured to operate the display by effectively switching or changing the applied bias to one or more of the front and rear electrodes. In one embodiment, the instructions may include biasing electrodes through power supply 550. When biased, the electrodes may cause movement of electrophoretic particles towards or away from a region proximal to the surface of the plurality of convex protrusions at the inward surface of the front transparent sheet to thereby absorb or reflect light received at the inward surface of the front transparent sheet. By appropriately biasing the electrodes, particles (e.g., particles 426 in FIG. 4) may be moved near the surface of the plurality of convex protrusions at the inward surface of the front transparent sheet into or near the evanescent wave region in order to substantially or selectively absorb or reflect the incoming light. Absorbing the incoming light creates a dark or colored state. By appropriately biasing the electrodes, particles (e.g., particles 426 in FIG. 4) may be moved away from the surface of the plurality of protrusions at the inward surface of the front transparent sheet and out of the evanescent wave region in order to reflect or absorb the incoming light. Reflecting the incoming light creates a light state.

The exemplary displays disclosed herein may be used as electronic book readers, portable computers, tablet computers, cellular telephones, smart cards, signs, watches, wearables, shelf labels, flash drives and outdoor billboards or outdoor signs comprising a display. The displays may be powered by one or more of a battery, solar cell, wind, electrical generator, electrical outlet, AC power, DC power or other means.

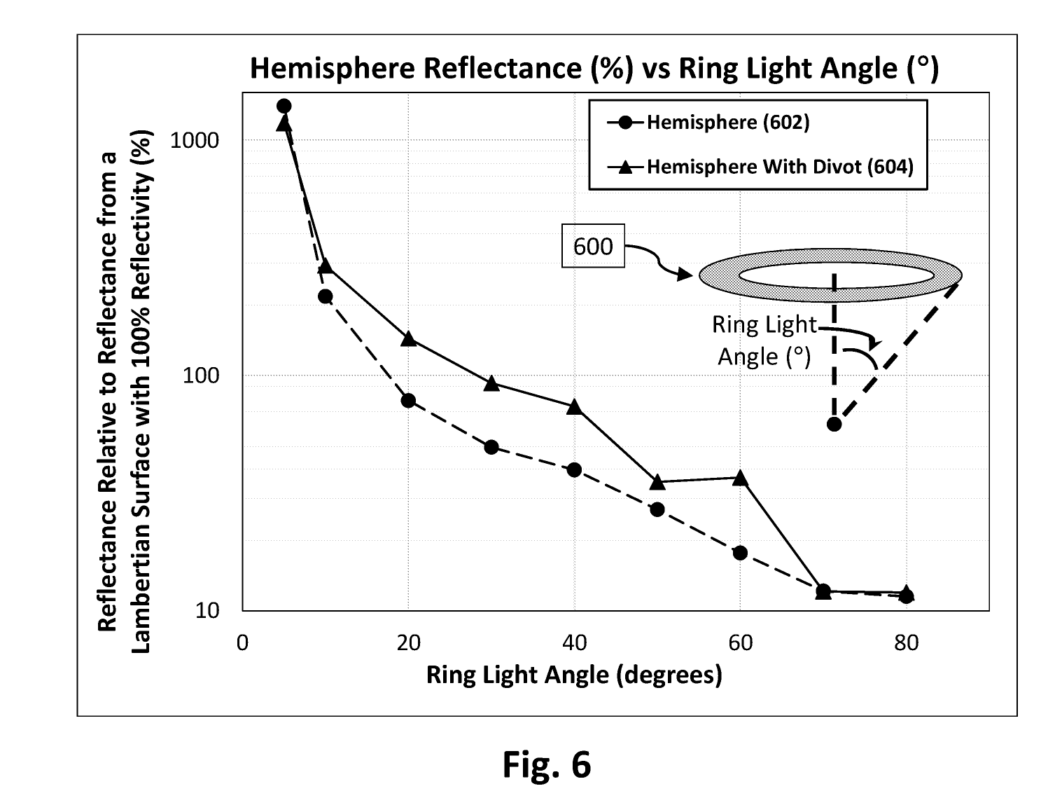

FIG. 6 graphically illustrates the results of a set of simulations. To support and illustrate the embodiments described herein, simulations of modeled systems have been carried out using Zemax Optical and Illumination Design software (version 16). The light source was a Lambertian ring light source with a variable radius that emits 550 nm wavelength monochromatic light (It should be noted that his data may also exhibit a similar response with a typical household light source). The reflectivity of the sample was measured as a function of the angle created by the sample and the outer edge of the ring light source. The experimental set-up is depicted in insert 600 in FIG. 6. The graph plots reflection (%) relative to the reflection of a 100% reflective Lambertian surface as measured with a detector that has a 2° acceptance angle as a function of the ring light angle. The dashed line with circular markers 602 in the plot in FIG. 6 is the reflectivity of a 100×100 array of hemispheres of about 1 millimeter in diameter. The solid line with triangular markers 604 in FIG. 6 is the reflectivity of a modified hemisphere of one millimeter diameter and with a cone-shaped divot as described previously herein. The surface of the cone-shaped divot has an angle 314 of about 45°. As shown in the graph the hemisphere with a divot 604 may exhibit enhanced reflectivity compared to a non-modified hemisphere 602 when the ring light angles are in the range of about 10-70°.

The following exemplary and non-limiting embodiments provide various implementations of the disclosure. Example 1 is directed to a structure for a Totally Internally Reflective (TIR) display, comprising: a transparent front sheet having a top surface and a bottom surface, the top surface defining a substantially planar surface and the bottom surface comprising a plurality of adjacent protrusions with at least one protrusion defining a cavity; wherein each cavity further comprises, at least partially, a coating on the exposed surface of the cavity, the coating comprising one or more light-reflecting materials; and wherein the walls of the cavity are angled to provide specular reflection of an incoming ray of light from the transparent front sheet.

Example 2 is directed to the structure of example 1, wherein at least one cavity is configured to receive at least one electrophoretically mobile particle.

Example 3 is directed to the structure of example 1, further comprising a transparent front electrode associated with the transparent front sheet.

Example 4 is directed to the structure of example 3, wherein the transparent front electrode further comprises one or more of indium tin oxide (ITO), an electrically conductive polymer or conductive nano-particles dispersed in a polymer.

Example 5 is directed to the structure of example 3, wherein the cavity of at least one of the plurality of adjacent protrusions is shaped as one or more of a cone, a prism, rectangular or circular.

Example 6 is directed to the structure of example 1, wherein the coating further comprises one or more of a metal or TiO₂.

Example 7 is directed to the structure of example 1, wherein the protrusions comprises a material having refractive index in a range of about 1.5-2.2.

Example 8 is directed to the structure of example 1, further comprising a dielectric layer covering one or more of the top or the rear electrodes.

Example 9 is directed to the structure of example 1, further comprising a color filter array layer.

Example 10 is directed to a Totally Internally Reflective (TIR) display, comprising: a transparent front sheet having a top surface and a bottom surface, the top surface defining a substantially planar surface and the bottom surface comprising a plurality of adjacent protrusions with at least one protrusion defining a cavity; a front electrode associated with the transparent front sheet; a rear electrode situated to form a cavity between the rear electrode and the transparent front sheet, the cavity configured to receive a transparent medium and one or more electrophoretically mobile particles that move responsive to a bias applied to the front electrode and the rear electrode.

Example 11 is directed to the display of example 10, wherein at least one cavity is configured to receive at least one electrophoretically mobile particle.

Example 12 is directed to the display of example 10, wherein each cavity further comprises, at least partially, a coating on the exposed surface of the cavity, the coating comprising one or more light-reflecting material.

Example 13 is directed to the display of example 10, wherein the walls of the cavity are angled to provide reflection of an incoming ray of light from the transparent front sheet.

Example 14 is directed to the display of example 10, further comprising a bias source engaged with the front electrode and to the rear electrode to form an electromagnetic field in the cavity.

Example 15 is directed to the display of example 14, further comprising a processor circuitry and a memory circuitry configured to control the bias source to thereby provide the electromagnetic field in the cavity.

Example 16 is directed to the display of example 10, wherein the front electrode further comprises one or more of indium tin oxide (ITO), an electrically conductive polymer or conductive nano-particles dispersed in a polymer.

Example 17 is directed to the display of example 10, wherein the cavity of at least one of the plurality of adjacent protrusions is shaped as one or more of a cone, a prism, rectangular or circular.

Example 18 is directed to the display of example 10, wherein the coating further comprises one or more of a metal or TiO₂.

Example 19 is directed to the display of example 10, wherein the protrusions comprises a material having refractive index in a range of about 1.5-2.2.

Example 20 is directed to the display of example 10, wherein the transparent medium has a refractive index in a range of about 1.1-1.4.

Example 21 is directed to the display of example 10, further comprising a dielectric layer covering one or more of the top or the rear electrodes.

Example 22 is directed to the display of example 10, further comprising a color filter array layer.

Example 23 is directed to a method to provide a Total Internal Reflection (TIR) at a display, the method comprising: positioning at least one electrophoretically mobile particle in a transparent medium disposed between a front electrode and rear electrode of an electrode pair, the front electrode associated with a transparent front sheet, the transparent front sheet having one or more adjacent protrusions to define a plurality of respective cavities protruding away from the transparent medium; receiving a first incident light at the transparent front sheet; biasing one or more of the electrodes in the electrode pair at a first bias to thereby move the at least one electrophoretically mobile particle to a region at or near the transparent front sheet and to absorb the first incident light; biasing one or more of the electrodes in the electrode pair at a second bias to thereby move the at least one electrophoretically mobile particle to a region at or near the bottom electrode; receiving a second incident light at the transparent sheet and one of (i) reflecting the second incident light by transmitting the second incident light between two adjacent cavities, or (ii) reflecting the second incident light by transmitting the second incident light between a cavity and an adjacent protrusion.

Example 24 is directed to the method of example 23, wherein each cavity further comprises, at least partially, a coating on an exposed surface of the cavity, the coating comprising one or more light-reflecting materials.

Example 25 is directed to the method of example 23, wherein the walls of the cavity are angled to provide reflection of an incoming ray of light from the transparent front sheet.

Example 26 is directed to the method of example 23, wherein a bias source is configured to engage the electrode pair to form an electromagnetic field in the cavity.

Example 27 is directed to the method of example 26, further comprising a processor circuitry and a memory circuitry configured to control the bias source to thereby provide the electromagnetic field in the cavity.

Example 28 is directed to the method of example 23, wherein the front electrode further comprises one or more of indium tin oxide (ITO), an electrically conductive polymer or conductive nano-particles dispersed in a polymer.

Example 29 is directed to the method of example 23, wherein the cavity of at least one of the plurality of adjacent protrusions is shaped as one or more of a cone, a prism, rectangular or circular.

Example 30 is directed to the method of example 23, wherein the coating further comprises one or more of a metal or TiO₂.

Example 31 is directed to the method of example 23, wherein the protrusions comprises a material having refractive index in a range of about 1.5-2.2.

While the principles of the disclosure have been illustrated in relation to the exemplary embodiments shown herein, the principles of the disclosure are not limited thereto and include any modification, variation or permutation thereof.

What is claimed is:

1. A structure for a Totally Internally Reflective (TIR) display, comprising:
a transparent front sheet having a top surface and a bottom surface, the top surface defining a substantially planar surface and the bottom surface comprising a plurality of adjacent protrusions with at least one protrusion defining a cavity;
wherein each cavity further comprises, at least partially, a coating on the exposed surface of the cavity, the coating comprising one or more light-reflecting materials; and
wherein the walls of the cavity are angled to provide specular reflection of an incoming ray of light from the transparent front sheet.

2. The structure of claim 1, wherein at least one cavity is configured to receive at least one electrophoretically mobile particle.

3. The structure of claim 1, further comprising a transparent front electrode associated with the transparent front sheet.

4. The structure of claim 3, wherein the transparent front electrode further comprises one or more of indium tin oxide (ITO), an electrically conductive polymer or conductive nano-particles dispersed in a polymer.

5. The structure of claim 3, wherein the cavity of at least one of the plurality of adjacent protrusions is shaped as one or more of a cone, a prism, rectangular or circular.

6. The structure of claim 1, wherein the coating further comprises one or more of a metal or TiO₂.

7. The structure of claim 1, wherein the protrusions comprise a material having refractive index in a range of about 1.5-2.2.

8. The structure of claim 1, further comprising a dielectric layer covering one or more of the top or the rear electrodes.

9. The structure of claim 1, further comprising a color filter array layer.

10. A Totally Internally Reflective (TIR) display, comprising:
a transparent front sheet having a top surface and a bottom surface, the top surface defining a substantially planar surface and the bottom surface comprising a plurality of adjacent protrusions with at least one protrusion defining a cavity;
a front electrode associated with the transparent front sheet;
a rear electrode situated to form a cavity between the rear electrode and the transparent front sheet, the cavity configured to receive a transparent medium and one or more electrophoretically mobile particles that move responsive to a bias applied to the front electrode and the rear electrode.

11. The display of claim 10, wherein at least one cavity is configured to receive at least one electrophoretically mobile particle.

12. The display of claim 10, wherein each cavity further comprises, at least partially, a coating on the exposed surface of the cavity, the coating comprising one or more light-reflecting material.

13. The display of claim 10, wherein the walls of the cavity are angled to provide reflection of an incoming ray of light from the transparent front sheet.

14. The display of claim 10, further comprising a bias source engaged with the front electrode and to the rear electrode to form an electromagnetic field in the cavity.

15. The display of claim 14, further comprising a processor circuitry and a memory circuitry configured to control the bias source to thereby provide the electromagnetic field in the cavity.

16. The display of claim 10, wherein the front electrode further comprises one or more of indium tin oxide (ITO), an electrically conductive polymer or conductive nano-particles dispersed in a polymer.

17. The display of claim 10, wherein the cavity of at least one of the plurality of adjacent protrusions is shaped as one or more of a cone, a prism, rectangular or circular.

18. The display of claim 10, wherein the coating further comprises one or more of a metal or TiO₂.

19. The display of claim 10, wherein the protrusions comprise a material having refractive index in a range of about 1.5-2.2.

20. The display of claim 10, wherein the transparent medium has a refractive index in a range of about 1.1-1.4.

21. The display of claim 10, further comprising a dielectric layer covering one or more of the top or the rear electrodes.

22. The display of claim 10, further comprising a color filter array layer.

23. A method to provide a Total Internal Reflection (TIR) at a display, the method comprising:
positioning at least one electrophoretically mobile particle in a transparent medium disposed between a front electrode and rear electrode of an electrode pair, the front electrode associated with a transparent front sheet, the transparent front sheet having one or more adjacent protrusions to define a plurality of respective cavities protruding away from the transparent medium;
receiving a first incident light at the transparent front sheet;
biasing one or more of the electrodes in the electrode pair at a first bias to thereby move the at least one electrophoretically mobile particle to a region at or near the transparent front sheet and to absorb the first incident light;
biasing one or more of the electrodes in the electrode pair at a second bias to thereby move the at least one electrophoretically mobile particle to a region at or near the bottom electrode;
receiving a second incident light at the transparent front sheet and one of (i) reflecting the second incident light by transmitting the second incident light between two adjacent cavities, or (ii) reflecting the second incident light by transmitting the second incident light between a cavity and an adjacent protrusion.

24. The method of claim 23, wherein each cavity further comprises, at least partially, a coating on an exposed surface of the cavity, the coating comprising one or more light-reflecting materials.

25. The method of claim 23, wherein the walls of the cavity are angled to provide reflection of an incoming ray of light from the transparent front sheet.

26. The method of claim 23, wherein a bias source is configured to engage the electrode pair to form an electromagnetic field in the cavity.

27. The method of claim 26, further comprising a processor circuitry and a memory circuitry configured to control the bias source to thereby provide the electromagnetic field in the cavity.

28. The method of claim 23, wherein the front electrode further comprises one or more of indium tin oxide (ITO), an electrically conductive polymer or conductive nano-particles dispersed in a polymer.

29. The method of claim 23, wherein the cavity of at least one of the plurality of adjacent protrusions is shaped as one or more of a cone, a prism, rectangular or circular.

30. The method of claim 23, wherein the coating further comprises one or more of a metal or TiO₂.

31. The method of claim 23, wherein the protrusions comprise a material having refractive index in a range of about 1.5-2.2.
